(19) United States
(12) Patent Application Publication
(10) Pub. No.: US 2017/0228510 A1
(43) Pub. Date: Aug. 10, 2017

(54) OVERLAY GRAPHICAL USER INTERFACE FOR MEDICAL DEVICES

(71) Applicant: Boston Scientific Neuromodulation Corporation, Valencia, CA (US)

(72) Inventor: Dennis Zottola, Ventura, CA (US)

(21) Appl. No.: 15/427,386

(22) Filed: Feb. 8, 2017

Related U.S. Application Data
(60) Provisional application No. 62/293,610, filed on Feb. 10, 2016.

(51) Int. Cl. G06F 19/00; G06F 3/0484

(52) U.S. Cl. CPC G06F 19/3406; G06F 3/04847; G06F 3/0482

(57) ABSTRACT

Disclosed in some examples are methods, systems, and machine readable mediums for operation of an overlay graphical user interface (GUI). The overlay GUI controls a neurostimulation system by translating inputs entered into the overlay GUI into commands that are sent as inputs to the standard GUI of the standard neurostimulation configuration application. This overlay GUI may be customized to the role of the expected user of the overlay GUI. For example, an overlay GUI may be simplified for a patient. The overlay GUI is different than the standard GUI provided by the standard neurostimulation configuration application in at least one GUI element. GUI elements may include user input controls (e.g., buttons, input entry boxes, dropdown selection controls), layout, presentation, and graphics.

### PRIORITY CLAIM

This application claims the benefit of priority under 35 U.S.C. §119(e) of U.S. Provisional Patent Application Ser. No. 62/293,610, filed on Feb. 10, 2016, which is herein incorporated by reference in its entirety.

### TECHNICAL FIELD

Embodiments pertain to Graphical User Interfaces (GUIs). Some embodiments relate to GUIs for medical devices.

### BACKGROUND

Some medical devices deliver electrical signals to one or more locations in or on a human body to provide therapy for a patient. In some examples, medical devices may have implantable components that are implanted in various locations of a human body. For example, a medical device may have a stimulator connected to one or more implanted electrodes through a lead system. These medical devices deliver the electrical signals using stimulation parameters that specify spatial (where to stimulate), temporal (when to stimulate), and informational (patterns of pulses) aspects of the electrical signals.

One example of such a medical device includes neurostimulation devices. Examples of neurostimulation include Spinal Cord Stimulation (SCS), Deep Brain Stimulation (DBS), Peripheral Nerve Stimulation (PNS), and Functional Electrical Stimulation (FES), and the like. To program these medical devices, in some examples an external programming device is used that communicates the stimulation parameters to the medical device using wired or wireless technologies. A user utilizes a user interface—typically a Graphical User Interface (GUI) provided by a configuration application running on the programming device to modify the settings or parameters on the medical device.

### SUMMARY

Example 1 includes subject matter (such as a device, apparatus, or machine) comprising: a processor; and a memory device comprising instructions, which when executed by the processor, cause the processor to at least: render a first graphical user interface (GUI) associated with a device configuration application on a display; render a second GUI using the computer processor, the second. GUI associated with an overlay application; receive an input from an input device communicatively coupled with the computer processor, the input directed toward the second GUI; responsive to receiving the input, determine, using the overlay application, a command to an element of the first GUI associated with the device configuration application; and issue the command to the first GUI.

In Example 2, the subject matter of Example 1 may include, wherein the instructions cause the processor to at least: receive, at the device configuration application, the command; and responsive to receiving the command, send a programming command from the device configuration application to an implantable stimulation device.

In Example 3, the subject matter of any one of Examples 1 to 2 may include, wherein the programming command changes a stimulation parameter of the implantable stimulation device.

In Example 4, the subject matter of any one of Examples 1 to 3 may include, wherein the input selects a stimulation program that is not available as a selection on the first GUI, the stimulation program a plurality of stimulation parameters for the medical device, and wherein the command to the first GUI comprises a command to set at least one of the plurality of stimulation parameters in a custom program mode of the first GUI.

In Example 5, the subject matter of any one of Examples 1 to 4 may include, wherein the instructions to cause the processor to issue the command to the first GUI cause the processor to at least use a method provided by an operating system to pass the command to the first GUI.

In Example 6, the subject matter of any one of Examples 1 to 5 may include, wherein the instructions to cause the processor to issue the command cause the processor to at least pass the command to a callback function of the first GUI registered with an operating system to handle input on a user interface element of the first GUI.

In Example 7, the subject matter of any one of Examples 1 to 6 may include, wherein second GUI allows for adjusting a number of stimulation parameters that is less than a number of adjustable stimulation parameters of the first GUI,

In Example 8, the subject matter of any one of Examples 1 to 7 may include, wherein the second GUI provides a wizard for adjusting one or more stimulation parameters of the medical device, the wizard a plurality of steps.

In Example 9, the subject matter of any one of Examples 1 to 8 may include, wherein the input is a selection of a steering algorithm and wherein the command to the element of the first GUI is a command to alter a stimulation parameter to at effectuate, at least in part, the steering algorithm.

In Example 10, the subject matter of any one of Examples 1 to 9 may include, wherein the instructions that cause the processor to determine the command to the element of the first GUI associated comprises instructions to cause the processor to at least: find a corresponding rule associated with the overlay application; and apply the command specified in the corresponding rule,

In Example 11, the subject matter of any one of Examples 1 to 10 may include, wherein the instructions cause the processor to at least issue a second command to the first GUI responsive to receiving the input.

In Example 12, the subject matter of any one of Examples 1 to 11 may include, wherein the instructions that cause the processor to issue the command to the first GUI comprises instructions that cause the processor to at least use an Application Programming Interface (API) of the device configuration application to pass the command to the first GUI.

In Example 13, the subject matter of any one of Examples 1 to 12 may include, wherein the instructions that cause the processor to render the second GUI comprises instructions that cause the processor to at least render additional help to a user that is not present on the first GUI.

In :Example 14, the subject matter of any one of Examples 1 to 13 may include, wherein the instructions cause the processor to at least determine, using the overlay application, a first value displayed in the first GUI and display a second value derived from the first value on the second GUI.

Example 15 includes subject matter (such as a method, means for performing acts, machine readable medium including instructions that when performed by a machine cause the machine to performs acts, or an apparatus to perform) comprising: rendering a first graphical user interface (GUI) associated with a device configuration application on a display using a computer processor; rendering a second GUI using the computer processor, the second GUI associated with an overlay application; receiving an input from an input device communicatively coupled with the computer processor, the input directed toward the second GUI; responsive to receiving the input, determining, using the overlay application, a command to an element of the first GUI associated with the device configuration application; and issuing the command to the first GUI.

In Example 16, the subject matter of Example 15 may include, receiving, at the device configuration application, the command; and responsive to receiving the command, sending a programming command from the device configuration application to an implantable stimulation device.

In Example 17, the subject matter of any one of Examples 15 to 16 may include, wherein the programming command changes a stimulation parameter of the implantable stimulation device.

In Example 18, the subject matter of any one of Examples 15 to 17 may include, wherein the input selects a stimulation program that is not available as a selection on the first GUI, the stimulation program a plurality of stimulation parameters for the medical device, and wherein the command to the first GUI comprises a command to set at least one of the plurality of stimulation parameters in a custom program mode of the first GUI.

In Example 19, the subject matter of any one of Examples 15 to 18 may include, wherein issuing the command to the first GUI comprises using a method provided by an operating system to pass the command to the first GUI.

In Example 20, the subject matter of any one of Examples 15 to 19 may include, wherein the command to the first GUI is passed to a callback function of the first GUI registered with an operating system to handle input on a user interface element of the first GUI.

In Example 21, the subject matter of any one of Examples 15 to 20 may include, wherein second GUI allows for adjusting a number of stimulation parameters that is less than a number of adjustable stimulation parameters of the first GUI.

In Example 22, the subject matter of any one of Examples 15 to 21 may include, wherein the second GUI provides a wizard for adjusting one or more stimulation parameters of the medical device, the wizard a plurality of steps.

In Example 23, the subject matter of any one of Examples 15 to 22 may include, wherein the input is a selection of a steering algorithm and wherein the command to the element of the first GUI is a command to alter a stimulation parameter to at effectuate, at least in part, the steering algorithm.

In Example 24, the subject matter of any one of Examples 15 to 23 may include, wherein determining the command to the element of the first GUI associated comprises: finding a corresponding rule associated with the overlay application; and applying the command specified in the corresponding rule.

In Example 25, the subject matter of any one of Examples 15 to 24 may include, issuing a second command to the first GUI responsive to receiving the input.

In Example 26, the subject matter of any one of Examples 15 to 25 may include, wherein issuing the command to the first GUI comprises using Application Programming Interface (API) of the device configuration application to pass the command to the first GUI.

In Example 27, the subject matter of any one of Examples 15 to 26 may include, wherein rendering the second GUI comprises rendering additional help to a user that is not present on the first GUI.

In Example 28, the subject matter of any one of Examples 15 to 27 may include, using the overlay application, determining a first value displayed in the first GUI and displaying a second value derived from the first value in the second GUI.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic of a medical device system according to some examples of the present disclosure.

FIG. 2 illustrates a schematic of a medical device system according to some examples of the present disclosure.

FIG. 3 illustrates a schematic of an implantable medical device system and portions of an environment in which implantable medical device system may be used according to some examples of the present disclosure.

FIG. 4 illustrates a drawing of a programming device GUI and overlay GUI according to some examples of the present disclosure.

FIG. 5 illustrates a flowchart of a method of deployment of an overlay application to a programming device according to some examples of the present disclosure.

FIG. 6 illustrates a flowchart of a method of controlling a stimulation device using an overlay GUI according to some examples of the present disclosure.

FIG. 7 is a block diagram illustrating an example of a machine upon which one or more embodiments may be implemented.

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

Users of medical devices typically have varying degrees of experience and skills. Developing a single GUI that is intuitive and effective for these wide range of experiences and skills is challenging. Moreover, the programming devices and their configuration applications (including the user interface provided by the configuration applications) need to be approved by various regulatory agencies as they control the medical devices and impact patient health and safety. As a result, manufacturers typically only produce a single user interface with all the possible options and features that are configurable for the medical device.

Medical devices such as neurostimulators and implanatable neurostimulators may be highly complex and feature a number of configurable settings and parameters. As a result, the user interfaces for the programming devices may be complex. This complexity may be inappropriate for some users who may not want, need, or understand the plethora of options presented by these user interfaces. Furthermore, the expense and delay of the regulatory processes needed to approve these user interfaces limits adding functionality such as additional stimulation profiles at a later time. These problems limit the ability of the medical device system to adapt to customer needs.

Disclosed in some examples are methods, systems, and machine readable mediums for operation of an overlay graphical user interface (GUI). The overlay GUI controls a medical device by translating inputs entered into the overlay GUI into commands that are received as inputs by the GUI of the standard medical device configuration application. The GUI of the standard medical device configuration application may then translate these inputs into commands that are sent to the medical device. The standard medical device configuration application is the full-featured, regulatory agency approved configuration application. In contrast, the overlay GUI may be customized to the role of the expected user of the overlay GUI. For example, an overlay GUI may be simplified for a patient or a clinician, or other therapy provider such as a doctor or nurse. The overlay GUI is different than the GUI provided by the standard medical device configuration application by at least one GUI element. GUI elements may include user input controls (e.g., buttons, input entry boxes, dropdown selection controls), layout, presentation, and graphics.

In some examples, the overlay GUI is provided by a separate application termed an “overlay application.” The overlay application may be a separate application than the standard medical device configuration application and may be deployed independently of the standard medical device configuration application. The overlay GUI may be customized to the type of user (doctor, nurse, patient) with functionality and complexity appropriate for the desired end user. This allows for deployment of a single, complex and feature rich standard GUI and one or more individually tailored overlay GUIs.

Since the overlay GUI acts upon the standard GUI, approval by regulatory agencies of the overlay GUIs may not be necessary. This is because the input validation and other safety checks of the standard GUI serve as a safeguard to ensure that patient safety is not compromised. This may also allow for updates to the overlay GUIs without obtaining regulatory approval.

The use of overlay GUIs also allows for the addition of new stimulation programs. A stimulation program comprises one or more stimulation parameters. Stimulation parameters may include which electrodes to apply the stimulation to (stimulation location), the duration of the stimulation, the time between stimulations, the waveform, the intensity, and the like. For example, a new stimulation program may be deployed with (or at a later time than) the overlay GUI and may be selectable in the overlay application GUI by use of a drop down box with a list of selectable profiles. When the profile is selected by the user, the profile includes commands that are then passed to the standard GUI to cause the standard GUI to program the profile into the stimulation device. For example, the standard GUI may have a tab or settings page where custom stimulation parameters may be entered. The overlay GUI may command the standard GUI to go into this custom configuration mode and the overlay GUI may automatically input the parameters of the custom stimulation program into various input GUI elements of the custom configuration screen of the standard GUI to recreate the custom stimulation program.

In addition to providing additional stimulation programs, the overlay GUI may also contain logic to add additional capabilities to the standard medical device configuration application. For example, the overlay application may include one or more algorithms to setup, or assist the user in setting up, the medical device. These algorithms may be part of the overlay application at deployment of the overlay application, or may be added later as an update to the overlay application. These algorithms may use input (e.g., sensor data, current settings, or the like) from the medical device determined from the medical device configuration application, and may output one or more commands to change one or more settings on the medical device configuration application.

For example, a new steering algorithm to setup the electrodes may be deployed with the overlay application. The steering algorithm may setup the medical device to steer the therapy to different parts of the body. The steering algorithm may issue commands to the medical device configuration application through the standard GUI to setup the electrodes, currents, and other stimulation parameters to effectuate the steering algorithm. As another example, the overlay GUI may also provide additional help information, or one or more wizards to assist the user in configuring the medical device. A wizard comprises a sequence of dialog boxes that lead the user through a series of well-defined steps to accomplish a task. The overlay GUI may provide enhanced visualizations of data retrieved from the medical device.

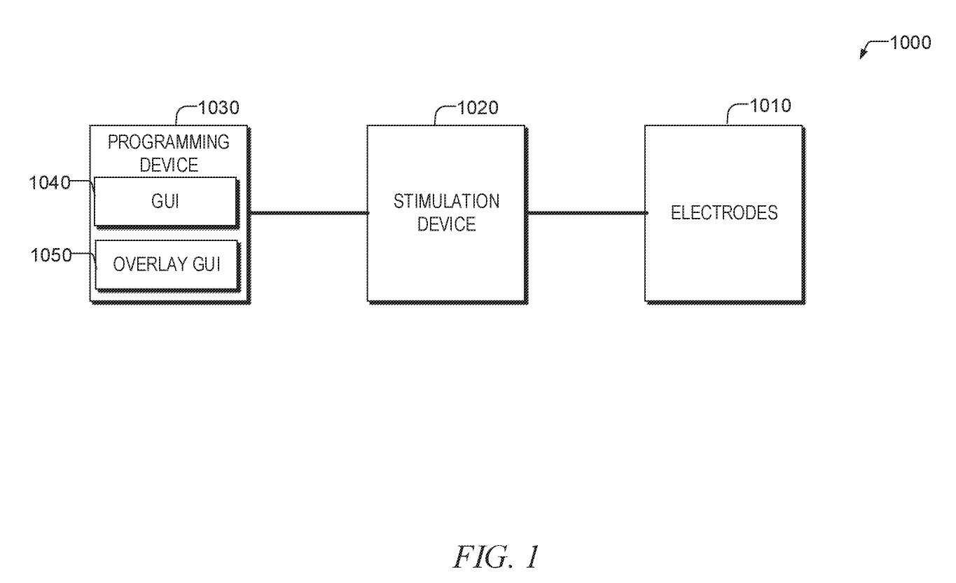

FIG. 1 illustrates an embodiment of a medical device system 1000. One example medical device system 1000 is a neurostimulation system. Medical device system 1000 includes one or more electrodes 1010, a stimulation device 1020, and a programming device 1030. Electrodes 1010 are configured to be placed on or near one or more targets in a patient (e.g., neural targets). Stimulation device 1020 is configured to be electrically connected to electrodes 1010 and deliver stimulation energy, such as in the form of electrical pulses, to the one or more targets though electrodes 1010. The delivery of the stimulation energy is controlled by using a plurality of stimulation parameters, such as stimulation parameters specifying a pattern of the electrical pulses and a selection of electrodes through which each of the electrical pulses is delivered. For example, stimulation device 1020 may be a neurostimulation device that is configured to be electrically connected to electrodes 1010 and deliver neurostimulation energy, such as in the form of electrical pulses, to the one or more neural targets though electrodes 1010.

In various embodiments, at least some parameters of the plurality of stimulation parameters are programmable by a user, such as a physician or other caregiver who treats the patient using medical device system 1000. Programming device 1030 provides the user with accessibility to the user-programmable parameters. In various embodiments, programming device 1030 is configured to be communicatively coupled to stimulation device 1020 via a wired or wireless link.

In various embodiments, programming device 1030 includes a graphical user interface (GUI) 1040 that allows the user to set and/or adjust values of the user-programmable parameters by creating and/or editing graphical representations of various waveforms. Such waveforms may include, for example, the waveform of a pattern of stimulation pulses to be delivered to the patient as well as individual waveforms that are used as building blocks of the pattern of stimulation pulses. Examples of such individual waveforms include pulses, pulse groups, and groups of pulse groups, as further discussed below. The user may also be allowed to define an electrode selection specific to each individually defined waveform. GUI 1040 may be created by a medical device configuration application.

The user can input one or more parameters using the GUI 1040, for example, that at least partially define a stimulation field. Example parameters that can be of interest include, but are not limited to the following: amplitude, pulse width, frequency, total charge injected per unit time, cycling (e.g., on/off time), pulse shape, number of phases, phase order, interphase time, charge balance, ramping, as well as spatial variance (e.g., electrode configuration changes over time). For example, as described in more detail below, the GUI 1040 of the programming device 1030 can receive user input that at least partially defines a neuromodulation field to provide the neurostimulation therapy to a patient. Based on the received user input, the programming device 1030 can determine a subset of available electrodes and current distributions for the subset to generate the field.

In some examples, programming device 1030 may include an overlay GUI 1050. The overlay GUI may provide a user interface that contains at least one element that is different than a user interface provided by GUI 1040. In some examples, both GUI 1040 and overlay GUI 1050 may be rendered on a display of the programming device 1030. The overlay GUI 1050 may be rendered and controlled by an overlay application. Responsive to receiving one or more inputs directed to the overlay GUI 1050, the overlay application may determine a command to issue to an element of the GUI 1040. The overlay application may then issue this command. The overlay GUI 1050 may therefore control the GUI 1040.

Portions of the stimulation device 1020, e.g., implantable medical device, or the programming device 1030 can be implemented using hardware, software, or any combination of hardware and software. Portions of the stimulation device 1020 or the programming device 1030 may be implemented using an application-specific circuit that can be constructed or configured to perform one or more particular functions, or can be implemented using a general-purpose circuit that can be programmed or otherwise configured to perform one or more particular functions. Such a general-purpose circuit can include a microprocessor or a portion thereof, a microcontroller or a portion thereof, or a programmable logic circuit, or a portion thereof. The medical device system 1000 could include a subcutaneous medical device (e.g., subcutaneous ICD, subcutaneous diagnostic device), wearable medical devices (e.g., patch based sensing device), or other external medical devices. Programming device 1030 may also include memory devices, input devices, and display devices.

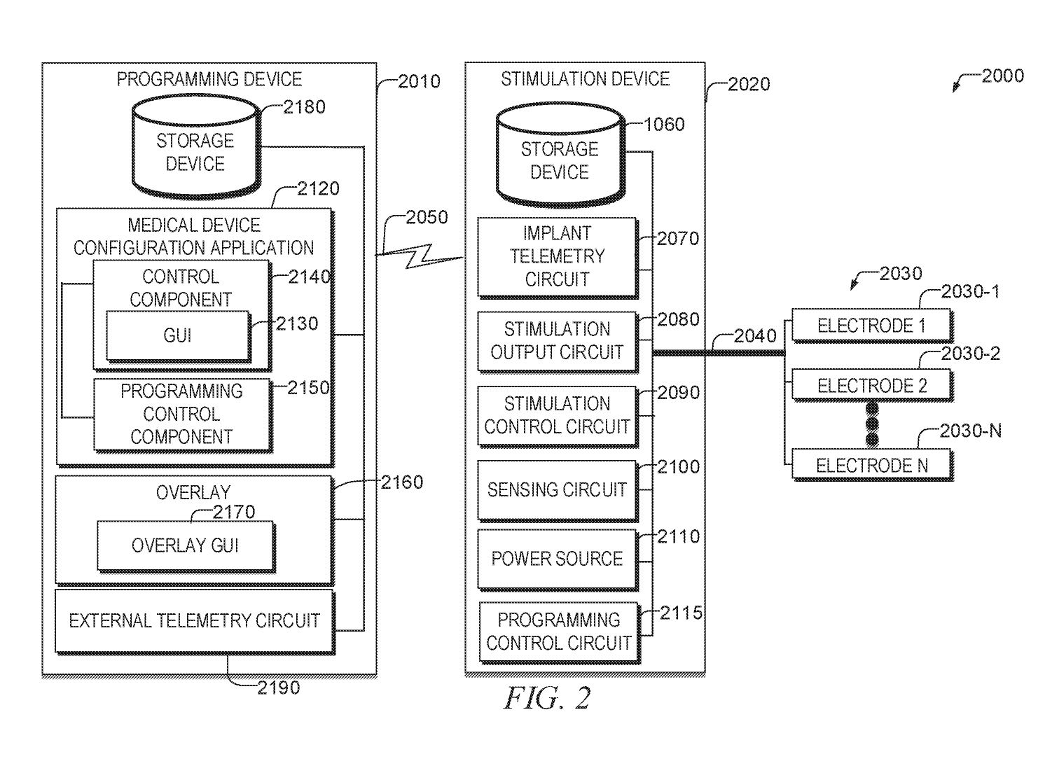

FIG. 2 illustrates a schematic of a neurostimulation system 2000 according to some examples of the present disclosure. Neurostimulation system 2000 is an example of one embodiment of a medical device system 1000 of FIG. 1. Neurostimulation system 2000 includes electrodes 2030, a stimulation device 2020, and a programming device 2010. In some examples, the stimulation device 2020 is an implantable stimulation device. Electrodes 2030 are configured to be placed on or near one or more neural targets in a patient. Stimulation device 2020 is configured to be electrically connected to electrodes 2030 through a lead system 2040 and deliver neurostimulation energy, such as in the form of electrical pulses, to the one or more neural targets through electrodes 2030. The delivery of the neurostimulation is controlled by using a plurality of stimulation parameters, such as stimulation parameters specifying a pattern of the electrical pulses, an intensity of the electrical pulses, a waveform of the electrical pulses, a duration of the electrical pulses, a timing of the electrical pulses, a selection of electrodes through which each of the electrical pulses is delivered, and the like. In some examples, one or more of the plurality of stimulation parameters are programmable by a user, such as a physician or other caregiver who treats the patient using neurostimulation system 2000. Programming device 2010 provides the user with accessibility to the user-programmable parameters. In some examples, programming device 2010 is configured to be communicatively coupled to stimulation device 2020 via a wired or wireless link 2050.

Stimulation device 2020 includes one or more components. Example components include a storage device 2060, an implant telemetry circuit 2070, a stimulation output circuit 2080, a stimulation control circuit 2090, a sensing circuit 2100, a power source 2110, and a programming control circuit 2115. Stimulation device 2020 may have some of the components shown in FIG. 2, all of the components shown in FIG. 2, or additional components not shown in FIG. 2.

Power source 2110 provides stimulation device 2020 with energy for its operation. In one example, power source 2110 includes a battery. In one example, power source 2110 includes a rechargeable battery and a battery charging circuit for charging the rechargeable battery. In addition to the functions described below, implant telemetry circuit 2070 may also function as a power receiver that receives power transmitted from programming device 2010 through an inductive couple.

Stimulation control circuit 2090 controls the delivery of the neurostimulation pulses by controlling the stimulation output circuit 2080 using the plurality of stimulation parameters specifying the pattern of the neurostimulation pulses. Stimulation output circuit 2080 produces and delivers neurostimulation pulses, including a user-defined customized neurostimulation waveform received from programming device 2010 based upon commands sent from stimulation control circuit 2090 by using power generated by the power source 2110.

Lead system 2040 includes one or more leads configured to be electrically connected to stimulation device 2020 and a plurality of electrodes 2030 distributed in the one or more leads. The plurality of electrodes 2030 includes electrode 2030-1, electrode 2030-2 . . . electrode 2030-N. In some examples, the electrodes 2030 are single electrically conductive contacts providing for an electrical interface between stimulation output circuit 2080 and tissue of the patient, where N≧2. The neurostimulation pulses are delivered from stimulation output circuit 2080 through a set of electrodes selected from electrodes 2030 based upon the stimulation parameters. In various examples, the neurostimulation pulses may include one or more individually defined pulses, and the set of electrodes may be individually definable by the user for each of the individually defined pulses. In one example, stimulation control circuit 2090 controls the delivery of the neurostimulation pulses using one or more sensed physiological signals from sensing circuit 2100.

Sensing circuit 2100 senses one or more physiological signals for purposes of patient monitoring and/or feedback control of the neurostimulation. Examples of the one or more physiological signals includes neural and other signals indicative of a condition of the patient that is treated by the neurostimulation and/or a response of the patient to the delivery of the neurostimtulation. The output of the sensing circuit 2100 may be used to modify the stimulation parameters, including the time between stimulations, intensity of the stimulations, duration of the stimulations, and which of electrodes 2030 are stimulated. The output of the sensing circuit 2100 may be communicated to programming device 2010 where it may be displayed in GUI 2130 (or overlay GUI 2170).

Implant telemetry circuit 2070 provides stimulation device 2020 with wireless or wired communication with another device such as programming device 2010, including receiving settings and values of the plurality of stimulation parameters. Storage device 2060 stores values of the settings and plurality of stimulation parameters. Programming control circuit 2115 may implement one end of one or more communication protocols used to communicate with programming device 2010. Implant telemetry circuit 2070 and programming control circuit 2115 receive, decode, authenticate, and store in storage device 2060 one or more settings and stimulation parameters. Implant telemetry circuit 2070 and programming control circuit 2115 package (e.g., packetize), encode, and send status information (including current settings and stimulation parameters), sensor data from sensing circuit 2100, and response information (e.g., acknowledgements). In some examples the implant telemetry circuit 2070 provides a physical layer link with the programming device 2010 while the programming control circuit 2115 provides one or more higher layer communication protocols. Wired or wireless links 2050 may be encrypted. In these examples, the encryption and decryption keys may be stored in storage device 2060 and storage device 2180.

In various examples, stimulation device 2020 is encapsulated in a hermetically sealed implantable housing. In various examples, lead(s) 2040 are implanted such that electrodes 2030 are placed on and/or around one or more targets to which the neurostimulation pulses are to be delivered, while stimulation device 2020 is subcutaneously implanted and connected to lead(s) 2040 at the time of implantation.

The stimulation device 2020 may be configured to modulate spinal target tissue or other neural tissue. The configuration of electrodes 2030 used to deliver electrical pulses to the targeted tissue constitutes an electrode configuration, with the electrodes capable of being selectively programmed to act as anodes (positive), cathodes (negative), or left off (zero). In other words, an electrode configuration represents the polarity being positive, negative, or zero. Other parameters that may be controlled or varied include the amplitude, pulse width, and rate (or frequency) of the electrical pulses. Each electrode configuration, along with the electrical pulse parameters, can be referred to as a “modulation parameter” set. Each set of modulation parameters, including fractionalized current distribution to the electrodes (as percentage cathodic current, percentage anodic current, or off), may be stored and combined into a program that can then be used to modulate multiple regions within the patient.

The neurostimulation system 2000 may he configured to deliver different electrical fields to achieve a temporal summation of modulation. The electrical fields can be generated respectively on a pulse-by-pulse basis. For example, a first electrical field can be generated by the electrodes (using a first current fractionalization) during a first electrical pulse of the pulsed waveform, a second different electrical field can be generated by the electrodes (using a second different current fractionalization) during a second electrical pulse of the pulsed waveform, a third different electrical field can be generated by the electrodes (using a third different current fractionalization) during a third electrical pulse of the pulsed waveform, a fourth different electrical field can be generated by the electrodes (using a fourth different current fractionalized) during a fourth electrical pulse of the pulsed waveform, and so forth. These electrical fields can be rotated or cycled through multiple times under a timing scheme, where each field is implemented using a timing channel. The electrical fields may be generated at a continuous pulse rate, or as bursts of pulses. Furthermore, the interpulse interval (i.e., the time between adjacent pulses), pulse amplitude, and pulse duration during the electrical field cycles may be uniform or may vary within the electrical field cycle. Some examples are configured to determine a modulation parameter set to create a field shape to provide a broad and uniform modulation field such as may be useful to prime targeted neural tissue with sub-perception modulation. Some examples are configured to determine a modulation parameter set to create a field shape to reduce or minimize modulation of non-targeted tissue (e.g., dorsal column tissue). Various examples disclosed herein are directed to shaping the modulation field to enhance modulation of some neural structures and diminish modulation at other neural structures. The modulation field may be shaped by using multiple independent current control (MICC) or multiple independent voltage control to guide the estimate of current fractionalization among multiple electrodes and estimate a total amplitude that provide a desired strength. For example, the modulation field may be shaped to enhance the modulation of dorsal horn neural tissue and to minimize the modulation of dorsal column tissue. A benefit of MICC is that MICC accounts for various in electrode-tissue coupling efficiency and perception threshold at each individual contact, so that “hotspot” stimulation is eliminated.

Programming device 2010 may exchange data with stimulation device 2020 over one or more wired or wireless links 2050. Programming device 2010 may change one or more settings of stimulation device 2020. Programming device 2010 may include a storage device 2180, a medical device configuration application a control component 2140, GUI 2130, programming control component 2150, overlay application 2160, overlay GUI 2170, and external telemetry circuit 2190. Programming device 2010 may have some of the components shown in FIG. 2, all of the components shown in FIG. 2, or additional components not shown in FIG. 2.

Example wireless links may include radio frequency links, magnetic coupling links, and the like. For example a BLUETOOTH® wireless link operating according to a BLUETOOTH standard promulgated by the BLUETOOTH® Special interest Group (SIG). Programming device 2010 may receive one or more current stimulation parameters or other settings of the stimulation device 2020 (which may be stored in storage device 2060). Programming device 2010 may also receive sensing data from the sensing circuit 2100. Programming device 2010 may display the data received from the stimulation device 2020 in GUI 2130 (and in some examples overlay GUI 2170). Programming device 2010 may change one or more settings or one or more stimulation parameters of the stimulation device 2020 by issuing one or more programming commands to the stimulation device 2020. In some examples, programming device 2010 may be a specially created computing device, but in other examples, the programming device 2010 may be a general computing device that is configured by one or more applications to communicate with stimulation device 2020. For example, a laptop computer, a desktop computer, a tablet computer, a smartphone, or the like.

In various examples, programming device 2010 includes a medical device configuration application 2120 Medical device configuration application 2120 includes a control component 2140 which creates and controls a Graphical User Interface (GUI) 2130 to provide an interface for the user to view, set, and adjust values of the user-programmable parameters and settings of the stimulation device 2020. For example, the user may creating and/or edit various waveforms through GUI 2130. Such waveforms may include, for example, the waveform of a pattern of neurostimulation pulses to be delivered to the patient as well as individual waveforms that are used as building blocks of the pattern of neurostimulation pulses. Examples of such individual waveforms include pulses, pulse groups, and groups of pulse groups. The user may also be allowed to define an electrode selection specific to each individually defined waveform.

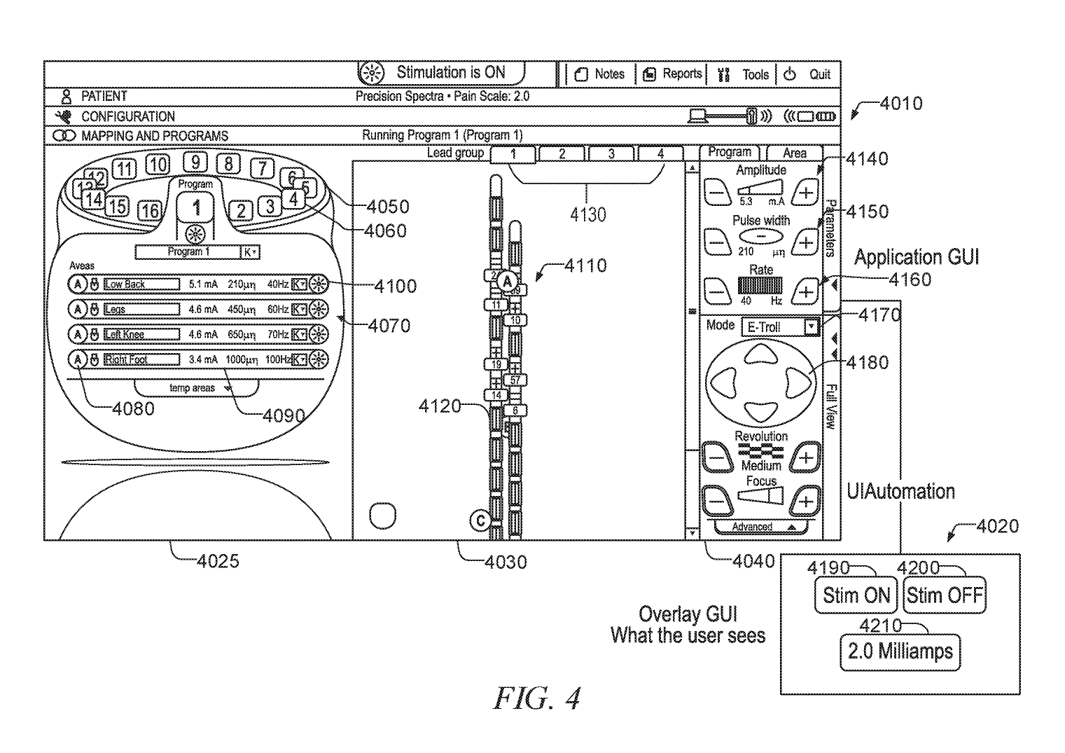

The GUI 2130 may graphically display one or more GUI elements such as graphics, text, and user input controls. GUI 2130 may be rendered to a display device communicatively coupled or integral to the programming device 2010. The user can input or change one or more parameters and settings through GUI 2130 using an input device (e.g., a mouse, keyboard, touchscreen). Example parameters that may be changed include, but are not limited to the following: amplitude, pulse width, frequency, total charge injected per unit time, cycling (e.g., on/off time), pulse shape, number of phases, phase order, interphase time, charge balance, ramping, as well as spatial variance (e.g., electrode configuration changes over time). In one example, GUI 2130 outputs an interactive screen that displays a graphical representation of a stimulation waveform and allows the user to adjust the waveform by graphically editing the waveform and/or various building blocks of the waveform. GUI 2130 may also allow the user to perform any other functions discussed in this document where graphical editing is suitable as may be appreciated by those skilled in the art. FIG. 4 shows one example 4010 of a GUI 2130. Based on the received user input, the medical device configuration application 2120 can determine a subset of available electrodes and current distributions for the subset to generate the field. In some examples, medical device configuration application 2120 checks values of the plurality of stimulation parameters against safety rules to limit these values within constraints of the safety rules. In one example, the safety rules are heuristic rules.

In various examples, medical device configuration application 2120 allows the user to schedule delivery of neurostimulation programs, such as by specifying delivery time for certain building blocks and a frequency at which the program is delivered. In various examples, medical device configuration application 2120 allows the user to create each building block or program using one or more waveforms stored in storage device 2180 as templates. In various embodiments, medical device configuration application 2120 allows each newly created building block or program to be saved as additional waveforms stored in storage device 2180.

External telemetry circuit 2190 provides programming device 2010 with wired or wireless communication with another device such as stimulation device 2020 via wired or wireless links 2050, including transmitting the plurality of stimulation parameters or settings to stimulation device 2020. In one example, external telemetry circuit 2190 also transmits power to stimulation device 2020 through an inductive couple. In some examples the external telemetry circuit 2190 provides a physical layer link with the programming device 2010 while the programming control component 2150 provides one or more higher layer communication protocols. External telemetry circuit 2190 and programming control component 2150 receive, decode, authenticate, and store in storage device 2180 one or more settings, sensor readings, and stimulation parameters that are currently set at stimulation device 2020 across wired or wireless link 2050. External telemetry circuit 2190 and programming control component 2150 may package (e.g., packetize), encode, and send new settings, and new stimulation parameters to stimulation device 2020.

In various examples, programming device 2010 has operation modes including a composition mode and a real-time programming mode. Under the composition mode (also known as the pulse pattern composition mode), programming control component 2150 does not dynamically update values of the plurality of stimulation parameters on the stimulation device 2020 in response to any change in the one or more stimulation waveforms. These parameters may be changed once the user is ready, upon receiving a user input directed to a user input control in GUI 2130. Under the real-time programming mode programming control component 2150 dynamically updates values of the plurality of stimulation parameters in response to changes in the set of one or more stimulation waveforms, and transmits the plurality of stimulation parameters with the updated values to stimulation device 2020.

Storage device 2180 stores a plurality of existing neurostimulation waveforms, including individually definable waveforms each selectable for use as a portion of the pattern of the neurostimulation pulses. In various examples, waveforms of the plurality of individually definable waveforms includes one or more pulses of the neurostimulation pulses, and may include one or more other waveforms of the plurality of individually definable waveforms. Examples of such waveforms include pulses, pulse blocks, pulse trains, and train groupings, and programs. The existing waveforms stored in the storage device 2180 can be definable at least in part by one or more parameters including, but not limited to the following: amplitude, pulse width, frequency, electrode configurations, total charge injected per unit time, cycling (e.g., on/off time), pulse shape, number of phases, phase order, interphase time, charge balance, and ramping.

Storage device 2180 also stores a plurality of individually definable fields. Waveforms of the plurality of individually definable waveforms is associated with one or more fields of the plurality of individually definable fields. Fields of the plurality of individually definable fields are defined by one or more electrodes of the plurality of electrodes through which a pulse of the neurostimulation pulses is delivered and a current distribution of the pulse over the one or more electrodes.

As can be appreciated, the stimulation device 2020 may have a plethora of selectable options. For example, MICC parameters, electrode configurations, waveforms, and the like. This level of complexity may not be suitable for all users. In some examples, the programming device 2010 may have one or more overlay applications 2160 which may provide one or more overlay GUIs 2170. Overlay. GUI 2170 may have a graphical user interface (GUI) that is different in at least one visual aspect from the GUI 2130. For example, the overlay GUI 2170 may be a simplified version of GUI 2130 such that overlay GUI 2170 allows for changing a number of stimulation parameters that is less than a number of adjustable stimulation parameters and settings that the GUI 2130 allows for changing. In other examples, as already noted, overlay application 2160 may add capabilities that the standard medical device configuration application does not have.

In still other examples, both GUI 2130 and 2170 may be the same, but commands entered into the overlay GUI 2170 may have different effects. For example, pressing a rate increase button on the overlay GUI 2170 may produce a smaller rate increase or decrease than the same rate button of GUI 2130. In other examples, pressing a rate increase button on the overlay GUI 2170 may produce a larger rate increase or decrease than the same rate button of GUI 2130. In other examples, the rate button of the overlay GUI 2170 may look at the electrode configurations and have a different rate button behavior than the GUI 2130 depending on the electrode configurations.

Overlay application 2160 may translate one or more user inputs received by the overlay GUI 2170 to commands issued to GUI 2130. In some examples, commands issued to GUI 2130 utilize the same mechanisms in GUI 2130 that handle input from the user of the programming device 2010. For example, the overlay application 2160 may utilize frameworks (e.g., a UIAutomation class) provided by an operating system of programming device 2010 to monitor and control user interface elements of GUI 2130. This framework provides methods that when executed, causes the operating system to call code in the standard medical device configuration application that responds to user inputs directed to a specified user interface element of GUI 2130. For example, the overlay application 2160 may call a function provided by the operating system with an identifier of a GUI element of GUI 2130. The operating system may call the function of control component 2140 that was registered as the callback function of the GUI element of GUI 2130. This callback function is registered by the control component 2140 to handle user input directed to GUI 2130. This is similar to the way the operating system would call the callback function in the event an actual user input was directed to the GUI element of GUI 2130. The inputs issued to overlay GUI 2170 may be translated by logic in the overlay application 2160 to one or more of the same or different inputs to GUI 2130.

In other examples,other input simulation methods, functions, and procedures may be utilized. For example, low level system calls may be used to inject user inputs into the GUI 2130. In other examples, overlay application 2160 may use interprocess communication to input commands into the GUI 2130. For example, the standard medical device configuration application may have defined an Application Programming Interface (API) that includes methods that may he called by the overlay application to configure the medical device.

In a similar way, the overlay application 2160 may read values and information from the GUI 2130. For example, the overlay application 2160 may call a function provided by the operating system with an identifier of a GUI element of GUI 2130. The function may return the value of one or more displayed GUI elements, such as settings, parameters, graphics, and the like. This enables the overlay application to display and understand the current configuration of the stimulation device 2020. In some examples, the values read by the overlay application from GUI 2130 may be processed or modified by one or more applications or algorithms. The results of these modifications may be displayed on the GUI 2170. Thus, GUI 2170 may display values derived from values read from the GUI 2130.

In some examples, when a user of the programming device 2010 activates the overlay application 2160, the overlay application 2160 launches the medical device configuration application 2120. In other examples, the user activates both the overlay application 2160 and the medical device configuration application 2120 separately.

In some examples, the overlay application 2160 may be customized to assist users with disabilities. For example, the overlay application 2160 may be voice activated such that voice commands spoken by a user are translated into commands to the GUI 2130. In some examples, the features of GUI 2130 made available by the control component 2140 may depend on which version of an overlay application 2160 is installed. For example, if an overlay program directed to a patient is installed then the control component 2140 may expose only basic options. In contrast, if an overlay program directed to a doctor is installed, the control component 2140 may expose more advanced options.

In some examples, the overlay application 2160 may include additional help for users. For example, complicated tasks may be broken down using one or more wizards which lead users step-by-step through completion of the complicated task. Wizards are GUI screens which go step by step through a workflow corresponding to a task. In some examples, the overlay application 2160 may log user usage and provide this to a remote server to allow developers of the overlay application to improve the application.

The described components, applications, and circuits of the stimulation device 2020 and programming device 2010 can be implemented using hardware, software, or any combination of hardware and software. For example, the components, applications, and circuits may be implemented using an application-specific circuit that can be constricted or configured to perform one or more particular functions, or can be implemented using a general-purpose circuit that can be programmed or otherwise configured to perform one or more particular functions. Such a general-purpose circuit can include a microprocessor (e.g., a computer processor) or a portion thereof, a microcontroller or a portion thereof, or a programmable logic circuit, or a portion thereof. The neurostimulation system 2000 could include a subcutaneous medical device (e.g., subcutaneous ICD, subcutaneous diagnostic device), wearable medical devices (e.g., patch based sensing device), or other external medical devices. Programming device 2010 may be a special purpose device, or may be a general purpose device executing software. For example, programming device 2010 may be a tablet computer, a desktop computer, a laptop computer, or the like.

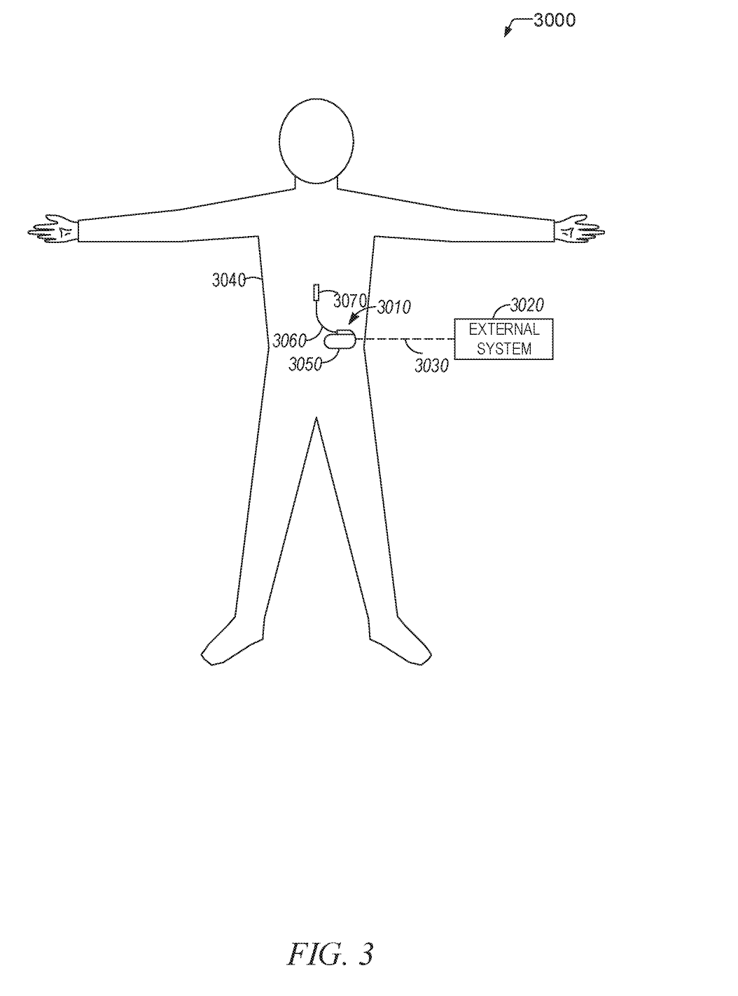

FIG. 3 illustrates a schematic of an implantable neurostimulation system 3000 and portions of an environment in which implantable neurostimulation system 3000 may be used according to some examples of the present disclosure. Implantable neurostimulation system 3000 includes an implantable system 3010, an external system 3020, and a telemetry link 3030 providing for wireless communication between implantable system 3010 and external system 3020. Implantable system 3010 is illustrated in FIG. 4 as being implanted in the patient's body 3040.

Implantable system 3010 includes an implantable stimulator (also referred to as an implantable pulse generator, or IPG) 3050, a lead system 3060, and electrodes 3070, which represent an example of stimulation device 2020, lead system 2040, and electrodes 2030, respectively. External system 3020 represents an example of programming device 2010.

In various examples, external system 3020 includes one or more external (non-implantable) devices allowing the user and/or the patient to communicate with implantable system 3010. In some examples, external system 3020 includes a programming device intended for the user to initialize and adjust settings for implantable stimulator 3050 and a remote control device intended for use by the patient. For example, the remote control device may allow the patient to turn implantable stimulator 3050 on and off and/or adjust certain patient-programmable parameters of the plurality of stimulation parameters.

Turning now to FIG. 4, a drawing of an example medical programming device GUI 4010 and overlay GUI 4020 are shown according to some examples of the present disclosure. Programming device GUI 4010 comprises three panels, a program selection panel 4025, a lead display panel 403 and a parameter adjustment panel 4040. Program selection panel 4025 provides information about modulation programs and coverage areas that have been, or may be defined for the stimulation. Program selection panel 4025 may comprise a carousel 4050 on which a plurality of modulation programs 4060 may be displayed and selected. The currently selected program (program 1) is displayed in the center of the carousel and its name is displayed below. A unique name may be assigned to each program. Program selection panel 4025 further comprises in some examples a plurality of coverage areas 4070 (in this case 4) with which a plurality of stimulation parameter sets can respectively he associated to create the current program. Each coverage area includes a designation field 4080 (one of the letters “A” through “D”) and an electrical stimulation parameter field 4090 displaying the stimulation parameters associated with that coverage area. Stimulation parameters displayed include the amplitude, pulse width, and pulse rate. Selection icon 4100 may be used to activate or deactivate the particular coverage area.

Lead display panel 4030 includes graphical leads 4110, which are illustrated with a plurality of graphical electrodes such as electrode 4120. The lead display panel 4030 further includes lead group selection tabs 4130 (in this case, four), any of which can be actuated to select one of four groups of graphical leads 4110. In this case, the first lead group selection tab 4130 has been actuated, thereby displaying the two graphical leads 4110 in their defined orientation. In the case where additional leads are implanted within the patient, they can be associated with additional lead groups.

The parameters adjustment panel 4040 also includes a pulse amplitude adjustment control 4140 (expressed in milliamperes (mA)), a pulse width adjustment control 4150 (expressed in microseconds (μs)), and a pulse rate adjustment control 4160 (expressed in Hertz (Hz)), which are displayed and actuatable. Each of the controls 4140-4160 includes a first arrow that can be actuated to decrease the value of the respective parameter and a second arrow that can be actuated to increase the value of the respective parameter. Each of the controls 4140-4160 also includes a display area for displaying the currently selected parameter.

The parameter adjustment panel 4040 includes a pull-down programming mode field 4170 that allows the user to switch between a manual programming mode, and electronic trolling programming mode, a navigation programming mode, an exploration programming mode, and a sub-threshold programming mode. Each of these programming modes allows a user to define a modulation parameter set for the currently selected coverage area 4070 of the currently selected program via manipulation of graphical controls in the parameter adjustment panel 4040 described above, as well as the various graphical controls described below.

The electronic trolling programming mode and navigation programming mode are designed to allow a user to determine one or more efficacious parameter sets for providing super-threshold therapy to the patient, whereas the exploration programming mode and sub-threshold programming mode are designed to allow the user to determine one or more efficacious parameter sets for providing sub-threshold therapy to the patient. In particular, the electronic trolling programming mode is designed to quickly sweep the electrode array using a limited number of electrode configurations to gradually steer an electrical field relative to the stimulation leads until the targeted site is located. Using the electrode configuration determined during the electronic trolling programming mode as a starting point, the navigation programming mode is designed to use a wide number of electrode configurations to shape the electrical field, thereby fine tuning and optimization the stimulation coverage for patient comfort. Both the electronic trolling mode and navigation programming mode rely on immediate feedback from the patient in response to the sensation of paresthesia relative to the region of the body in which the patient experiences pain. Like the electronic trolling programming mode, the exploration programming mode is designed to quickly sweep the electrode array using a limited number of electrode configurations to gradually steer an electrical field relative to the leads until the targeted modulation site is located. Like the electronic trolling mode, the exploration programming mode relies on immediate feedback from the patient in response to the sensation of paresthesia relative to the region of the body in which the patient experiences pain. However, unlike the electronic trolling programming mode, navigation programming mode, and exploration programming mode, the subthreshold programming mode cannot rely on immediate feedback from the patient due to the lack of paresthesia experience by the patient during sub-threshold modulation. Instead, the sub-threshold programming mode uses a transformation of the electrode configuration determined during the exploration programming mode to provide efficacious sub-threshold modulation to the determined target site of the patient.

In some examples, the parameter adjustment panel 4040 includes a steeling array of arrows 4180 that allows steering the electrical field up, down, left, or right relative to the electrodes. In the illustrated embodiment, the electrical current is steered by IO panning a virtual multipole (i.e., the virtual multipole is moved relative to the actual electrodes without changing the basic configuration (focus (F) and upper anode percentage (UAP)) of the virtual multipole), and computing the electrical amplitude values needed for the actual electrodes to emulate the virtual multipole.

As can be appreciated by the above discussion, the programming device GUI 4010 has numerous options and settings. This advanced user interface may be too advanced for some users. For example, patients may not be able to understand or utilize these settings. Shown in FIG. 4 is overlay GUI 4020, Overlay GUI 4020 has three buttons, a button to turn the stimulation on 4190, a button to turn stimulation off 4200 and a button to adjust the current level 4210. Each of buttons 4190-4210 may be translated by the overlay application into commands to issue to various user interface elements of GUI 4010. Thus, overlay GUI 4020 provides a simplified view of GUI 4010.

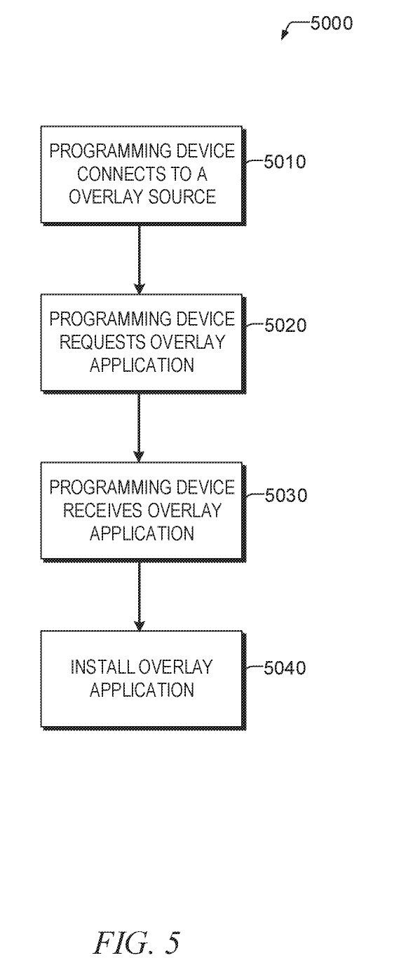

Turning now to FIG. 5, a flowchart of a method 5000 of deployment of an overlay application to a programming device is shown according to some examples of the present disclosure. FIG. 5 may be performed after the medical device configuration application is already been installed on the programming device. At operation 5010 the programming device connects with an overlay source. For example, the programming device may connect over a computer network to a server computer. In other examples, the programming device may connect to another programming device or other computing device. In still other examples, the overlay source may be a physical medium or other memory.

At operation 5020 the programming device requests an overlay application from the overlay source. For example, a user of the device may select from a list of overlay applications available on a remote server. The programming device may then download the overlay application from the overlay source over the computer network.

At operation 5030 the programming device receives the overlay application. For example, the remote server may send the overlay application over the computer network. In other examples, the programming device may transfer the overlay application from a physical media to a storage device of the programming device.

At operation 5040 the overlay application may be installed. In some examples, this may include installing files of the overlay application, registering files with an operating system of the programming device, verifying that the user of the programming device is authorized to use the overlay application, and the like.

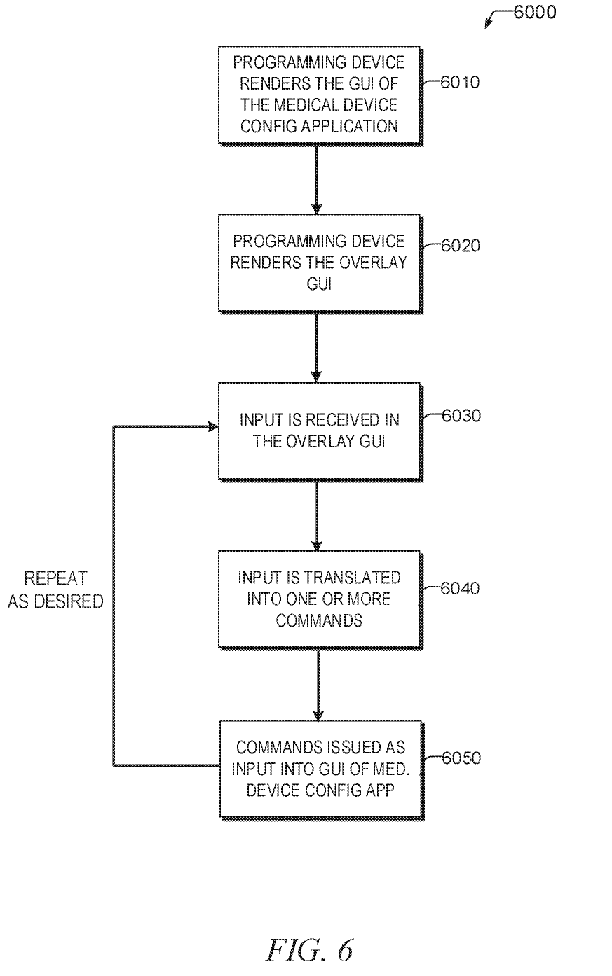

Turning now to FIG. 6 a flowchart of a method 6000 of controlling a stimulation device using an overlay GUI is shown according to some examples of the present disclosure. At operation 6010 the programming device renders the GUI of the medical device configuration application. For example, GUI 2130 of the medical device configuration application 2120 of FIG. 2 or 4010 of FIG. 4. The medical device configuration application includes instructions that cause the programming device to provide a GUI (such as GUI 2130) to a user and instructions to communicate with the stimulation device (e.g., stimulation device 2020) to change one or more settings or to provide one or more neurostimulation parameters in response to user input on the GUI. The GUI may be rendered on a display screen communicatively coupled to the programming device. In some examples, the GUI is not displayed on a display screen but is rendered to create an object model that describes the elements of the GUI. For example, in the context of a browser-based application, the rendering would create a Document Object Model (DOM). The object model allows programmatic access to the elements of the GUI. Operation 6010 may be performed in response to a user command to execute the medical device configuration application, or may be in response to the user command to execute the overlay application.

At operation 6020, the programming device renders the overlay GUI. The overlay application may provide and render an overlay GUI, such as overlay GUI 2170 from FIG. 2 or overlay GUI 4020 of FIG. 4, on the display screen communicatively coupled to the programming device 2010. The overlay GUI 2170 may be rendered on the same display screen as the GUI provided by the medical device configuration application, but in other examples, it may be provided to a different display. In some examples, the overlay GUI 2170 may be rendered on the same display screen grouping as the GUI provided by the medical device configuration application, but in other examples, it may be provided to a different display grouping. As used herein a display grouping is a group of one or more displays. For example, one display grouping may be a group of displays that are used by an operating system of the programming device 2010 to display the Graphical User Interface (GUI) of the Operating System (e.g., a virtual desktop).

In some examples, as part of operation 6020, the overlay application may display one or more current settings or sensor data of the medical device. The overlay application may retrieve this information from the medical device configuration application using operating system functions (such as UIAutomation) to access GUI elements of the GUI of the medical device configuration application. In some examples, commands may be issued to the medical device configuration application such that the information the overlay application wishes to display is displayed in the GUI of the medical device configuration application. For example, the medical device configuration application may be commanded to change to a different screen such that the information the overlay application wishes to display is actually displayed so that the overlay application can access the information.

At operation 6030 the overlay application receives input corresponding to the overlay GUI. The input may be from one or more input devices corresponding to the programming device. Example input devices include a mouse, a keyboard, a touchscreen display, a touchpad, a trackpad, a joystick, or the like. The input corresponds to the overlay GUI when an indication of the input is communicated to the overlay application by the operating system of the programming device. For example, when a graphical user interface element of the overlay GUI (such as a button, or other control) is activated, or is the target of the input, the operating system may call a pre-registered method, function, or routine (e.g., a callback function) of the overlay application that may handle the input.

At operation 6040 the input is translated into one or more commands by the overlay application. The commands may be determined using a plurality of rules. The rules may specify output commands based upon one or more inputs and conditions. For example, if the user selects a “stim on” button on the overlay GUI, the overlay program controller may determine based upon predetermined rules one or more commands to be issued to one or more user interface elements of the GUI rendered by the medical device configuration application to accomplish the desired function, such as turning stimulation on. These rules may specify the GUI element of the medical device configuration application and the input to enter on that element (e.g., a numerical value, a button press, a dropdown box selection, and the like). An example command may be issued to the operating system of the programming device 2010, which may provide an input on the user interface element of the GUI provided by the neurostimulation configuration application. Rules may be “if-then” rules of the form “if” input “then” issue command. For example, the overlay application may determine a corresponding rule based upon the user input directed to a GUI element of the overlay GUI. Based upon the corresponding rule, the rule may specify the command. Rules may be stored as a separate file on storage device of the programming device (e.g., such as storage device 2180) or may be integral with the overlay application. For example, rules may be changed after deployment of the overlay application by replacing the file on the storage device (for example, a downloadable update).

In some examples, new stimulation programs may he added to the programming device as an option after deployment of the medical device configuration application and even after deployment of the overlay application. For example, stimulation programs may be stored in a particular location (e.g., folder or directory) in a storage device of the programming device. The overlay application, when generating the overlay GUI may load stimulation programs found in the particular location and present them as selectable options. The programs contain the rules for translating the selection of the program into commands on the medical device configuration application's GUI. For example the commands may command the medical device configuration application to go to a custom program mode screen and may command the medical device configuration application to enter the desired parameters of the program as if they were coming from a user.

At operation 6050 the one or more commands may be issued as input to the medical device configuration application GUI. As already noted, the commands may be issued to the operating system of the programming device 2010, which may send an input to the medical device configuration application simulating an input on the user interface element of the GUI. For example, the UIAutomation framework of the operating system of the programming device may be used. The UIAutomation framework allows for access to and manipulation of GUI elements. In some examples, the operating system may call a callback function registered by the medical device configuration application to handle the desired input. Operations 6030-6050 may be repeated as desired by a user. Additionally, the overlay GUI may be changed or re-rendered as necessary given changes to the medical device or the medical device configuration application.

While some examples herein were described with reference to a neurostimulation device, one of ordinary skill with the benefit of this disclosure will appreciate that the overlay GUI may be applied to any medical device with a Graphical User Interface.

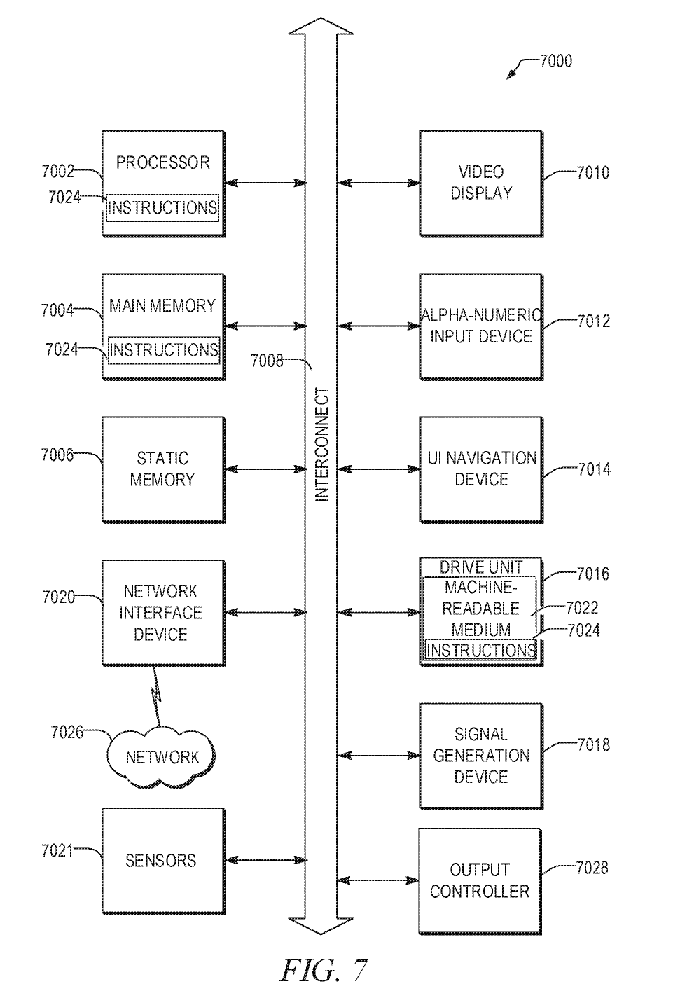

FIG. 7 illustrates a block diagram of an example machine 7000 upon which any one or more of the techniques (e.g., methodologies) discussed herein may be performed. The programming device 2010 or the stimulation device 2020 of FIG. 2 may be, or include one or more of the components of, the machine 7000 of FIG. 7. In alternative examples, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be a specialized computing device (neurostimulation programming device), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Components described herein may be described as programmers, applications, programs, controllers, circuits, or the like. These components may be implemented in many different ways. For example, these components may be implemented as dedicated hardware circuits, or may be implemented by reconfiguring a general purpose processor to perform the described functions. For example, the applications, programmers, programs, controllers, circuits, and the like may be modules.

Examples, as described herein, may include, or may operate on, logic or a number of components, modules, applications, circuits, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012. (e.g., a keyboard), and a user interface (UI) navigation device 6014 (e.g., a mouse), In an example, the display unit 6010, input device 6012 and UI navigation device 6014 may be a touch screen display. The machine 6000 may additionally include a storage device (e.g., drive unit) 6016, a signal generation device 6018 (e.g., a speaker), a network interface device 6020, and one or more sensors 6021, such as a global positioning system (GPS) sensor, compass, accelerometer, or other sensor. The machine 6000 may include an output controller 6028, such as a serial (e.g., universal serial bus (USB), parallel, or other wired or wireless (e.g., infrared(IR), near field communication (NFC), etc) connection to communicate or control one or more peripheral devices (e.g., a printer, card reader, etc).

The storage device 6016 may include a machine readable medium 6022 on which is stored one or more sets of data structures or instructions 6024 (e.g., software) embodying or utilized by any one or more of the techniques or functions described herein. The instructions 6024 may also reside, completely or at least partially, within the main memory 6004, within static memory 6006, or within the hardware processor 6002, during execution thereof by the machine 6000. In an example, one or any combination of the hardware processor 6002, the main memory 6004, the static memory 6006, or the storage device 6016 may constitute machine readable media.

While the machine readable medium 6022 is illustrated as a single medium, the term “machine readable medium” may include a single medium or multiple media (e.g., a centralized or distributed database, and/or associated caches and servers) configured to store the one or more instructions 6024.

The term “machine readable medium” may include any medium that is capable of storing, encoding, or carrying instructions for execution by the machine 6000 and that cause the machine 6000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 6024 may further be transmitted or received over a communications network 6026 using a transmission medium via the network interface device 6020. The Machine 6000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a. packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 6020 may include one or more physical jacks (e.g., Ethernet, coaxial, or phone jacks) or one or more antennas to connect to the communications network 6026. In an example, the network interface device 6020 may include a plurality of antennas to wirelessly communicate using at least one of single-input multiple-output (SIMO)), multiple-input multiple-output (MIMO), or multiple-input single-output (MISO) techniques. In some examples, the network interface device 6020 may wirelessly communicate using Multiple User MIMO techniques.

What is claimed is:

1. A method for controlling a medical device, the method comprising:
rendering a first graphical user interface (GUI) associated with a device configuration application on a display using a computer processor;
rendering a second GUI using the computer processor, the second GUI associated with an overlay application;
receiving an input from an input device communicatively coupled with the computer processor, the input directed toward the second GUI;
responsive to receiving the input, determining, using the overlay application, a command to an element of the first GUI associated with the device configuration application; and
issuing the command to the first GUI.

2. The method of claim 1, comprising:
receiving, at the device configuration application, the command; and
responsive to receiving the command, sending a programming command from the device configuration application to an implantable stimulation device.

3. The method of claim 1, comprising:
determining, using the overlay application, a first value displayed in the first GUI and displaying a second value derived from the first value on the second GUI.

4. The method of claim 1, wherein the input selects a stimulation program that is not available as a selection on the first GUI, the stimulation program comprising a plurality of stimulation parameters for the medical device, and wherein the command to the first GUI comprises a command to set at least one of the plurality of stimulation parameters in a custom program mode of the first GU.

5. The method of claim 1, wherein issuing the command to the first GUI comprises using a method provided by an operating system to pass the command to the first GUI.

6. The method of claim 5, wherein the command to the first GUI is passed to a callback function of the first GUI registered with an operating system to handle input on a user interface element of the first GUI.

7. The method of claim 1, wherein second GUI allows for adjusting a number of stimulation parameters that is less than a number of adjustable stimulation parameters of the first GUI.

8. The method of claim 1, wherein the second GUI provides a wizard for adjusting one or more stimulation parameters of the medical device, the wizard comprising a plurality of steps.

9. The method of claim 1, wherein the input is a selection of a steering algorithm and wherein the command to the element of the first GUI is a command to alter a stimulation parameter to at effectuate, at least in part, the steering algorithm.

10. The method of claim 1, wherein determining the command to the element of the first GUI associated comprises:
finding a corresponding rule associated with the overlay application; and
applying the command specified in the corresponding rule.

11. The method of claim 1, comprising issuing a second command to the first GUI responsive to receiving the input.

12. The method of claim 1, wherein issuing the command to the first GUI comprises using Application Programming Interface (API) of the device configuration application to pass the command to the first GUI.

13. A system comprising:
a processor; and
a memory device comprising instructions, which when executed by the processor, cause the processor to at least:
render a first graphical user interface (GUI) associated with a device configuration application on a display;
render a second GUI, the second GUI associated with an overlay application;
receive an input from an input device communicatively coupled with the processor, the input directed toward the second GUI;
responsive to receiving the input, determine, using the overlay application, a command to an element of the first GUI associated with the device configuration application; and
issue the command to the first GUI.

14. The system of claim 13, wherein the instructions cause the processor to at least:
receive, at the device configuration application, the command; and
responsive to receiving the command, send a programming command from the device configuration application to an implantable stimulation device.

15. The system of claim 14, wherein the programming command changes a stimulation parameter of the implantable stimulation device.

16. The system of claim 13, wherein the input selects a stimulation program that is not available as a selection on the first GUI, the stimulation program comprising a plurality of stimulation parameters for the medical device, and wherein the command to the first GUI comprises a command to set at least one of the plurality of stimulation parameters in a custom program mode of the first GUI.

17. The system of claim 13, wherein the instructions to cause the processor to issue the command to the first GUI cause the processor to at least use a method provided by an operating system to pass the command to the first GUI.

18. The system of claim 17, wherein the instructions to cause the processor to issue the command cause the processor to at least pass the command to a callback function of the first GUI registered with an operating system to handle input on a user interface element of the first GUI.

19. A non-transitory machine-readable medium including instructions, which when executed by a machine, causes the machine to perform the operations of:
rendering a first graphical user interface (GUI) associated with a device configuration application on a display using a computer processor;
rendering a second GUI using the computer processor, the second GUI associated with an overlay application;
receiving an input from an input device communicatively coupled with the computer processor, the input directed toward the second GUI;
responsive to receiving the input, determining, using the overlay application, a command to an element of the first GUI associated with the device configuration application; and
issuing the command to the first GUI.

20. The non-transitory machine-readable medium of claim 20, wherein the instructions comprise:
receiving, at the device configuration application, the command; and
responsive to receiving the command, sending a programming command from the device configuration application to an implantable stimulation device.
